(19) United States
(12) Patent Application Publication
(10) Pub. No.: US 2007/0298952 A1
(43) Pub. Date: Dec. 27, 2007

(54) Apparatus and Method for Creasing a Carton Board

(75) Inventors: Brian Blundell, Cheshire (GB); Mathew Faulkner, Cheshire (GB)

Correspondence Address: BIRCH STEWART KOLASCH & BIRCH, PO BOX 747, FALLS CHURCH, VA, 22040-0747, US

(73) Assignee: GENCIA LIMITED, Daresbury (GB)

(21) Appl. No.: 11/792,700

(22) PCT Filed: Dec. 7, 2005
(86) PCT No.: PCT/GB05/04715

§ 371 Date: Jun. 8, 2007

(30) Foreign Application Priority Data
Dec. 9, 2004 (GB) 0426996.5

(51) Int. Cl. B31B 1/25

(52) U.S. Cl. 493/60

(57) ABSTRACT

Apparatus (31) is provided for the creasing of a carton board (30). The apparatus (31) has a body (32) with a front surface (43) from which a creasing tool (41) mounted in the body (32) protrudes. The apparatus (31) has means providing an air pressure differential at the front surface (43) whereby the pressure differential acts across a carton board (30) when disposed across the front surface (43) to force the carton board (30) into deforming contact with the creasing tool (41). Preferably, the pressure differential is provided by suction to a slot (38) in a shoe (35) mounted on the body (32) and providing the front surface (43).

This invention relates to container production, and in particular to the production of cartons and corrugated boxes from cardboard blanks by folding.

Sample cartons and corrugated boxes, hereinafter simply referred to as cartons, are usually made by creasing and cutting a blank of the carton board material along predetermined fold lines. The creasing and cutting may be performed by hand or by use of a tangentially controlled knife and creasing wheel operating on the board supported by a flatbed “plotter” machine. Simply pushing a creasing wheel into the surface of a carton board or corrugated substrate supported on a flat plate does not produce a commercially acceptable crease, since the material displaced from the groove formed in the surface by the wheel has nowhere to go. In consequence, in the conventional high volume production process the carton board is supported by a channelled backing plate or “counter”. The channels in the counter are provided to receive the groove material displaced by the creasing wheel, and are of a suitable width so that the crease material can deform into the channels. The result is that a bead is formed on the underside of the board. To simulate this in sample making or short production runs on a sample-making table, a counter is usually cut from carton board or other suitable material. The counter channels have to be cut out and peeled away. During the creasing and cutting of the carton board, it is held down to the counter by vacuum, and the counter board in which the channels are cut has to have additional areas cut away to enable the vacuum to act on the carton board. The making of such a counter for a sample or short production run is time consuming and inconvenient. This problem is increased substantially when performing a short production run using a sheet feeder, conveyor or other transport mechanism to position the carton board prior to creasing/cutting, and a take-off mechanism to remove the carton board after that operation. By definition, the cartons produced during a short production run are intended for proper use, i.e. they are not samples or mock-ups. In consequence, the creases are required to be of production quality. This means that a counter must be cut for each different job to be done, and positioned so that the transported carton board is located exactly over the channels every time. Hence, the potential for short production runs is not being realised satisfactorily.

It is an object of the present invention to provide apparatus for and a method of the production of cartons that obviates at least to a substantial extent the disadvantages of the known apparatus and method.

The invention provides apparatus for the creasing of a carton board comprising a body having a front surface, a creasing tool mounted in the body, the creasing tool protruding from the front surface, and means providing an air pressure differential at the front surface whereby the pressure differential acts across a carton board when disposed across the front surface to force the carton board into deforming contact with the creasing tool.

The front surface may have an opening therein, the creasing tool protruding from the opening.

Preferably, the creasing tool is a wheel, which may be mounted in the body for rotation about an axis substantially parallel with the front surface.

The body may be an elongate hollow body having the front surface at and the opening in one end thereof. The opening may comprise a slot communicating with the hollow interior of the body. The hollow interior may be connected to the pressure differential providing means, which may be a fan, or may be a pump and air reservoir, and may include valve means operable to adjust the pressure differential. In this case, the pressure differential providing means may provide a sub-ambient air pressure in the hollow interior of the body. The front surface may have a low friction coating thereon, which coating may be of PTFE. The body may comprise a shoe on the one end thereof, the front surface being a surface of the shoe and the shoe having the opening extending therethrough. The shoe may have perforations therethrough whereby the sub-ambient pressure within the body causes a pressure differential across the shoe over a substantial area of the shoe. The shoe may be removable whereby shoes of differing dimensions may be mounted on the body.

The position of the creasing wheel may be adjustable relative to the body, whereby the extent of protrusion of the wheel from body may be adjusted. The creasing wheel may be removable from the body whereby wheels of differing dimensions may be mounted in the body. The creasing wheel may be may be mounted in the body to be rotatable about an axis substantially perpendicular to the front surface.

The apparatus may comprise a supporting mat on which a carton board is supported when in the apparatus. The mat may be porous to air and is of a material that is deformable under the load applied by the creasing wheel to a carton board.

The invention also provides a method of creasing a carton board comprising a body comprising bringing the carton board into contact with a front surface of a body, the front surface of which has an opening therein and a creasing tool mounted in the body, the creasing tool protruding from the opening, and providing an air pressure differential at the opening whereby the pressure differential acts across a carton board when disposed across the opening to force the carton board into deforming contact with the creasing tool.

The method may comprise creating a sub-ambient pressure within the body. Alternatively, the method may comprise directing pressure air at the front surface to force the carton board into deforming contact with the creasing tool.

The method may comprise adjusting the position of the creasing tool relative to the body whereby the extent of protrusion of the tool from body may be adjusted.

The method may comprise supporting a carton board on a supporting mat. The method may comprise supporting a carton board on a supporting mat that is porous to air and is of a material that is deformable under the load applied by the creasing wheel to a carton board.

The invention will now be described with reference to the accompanying drawing in which:

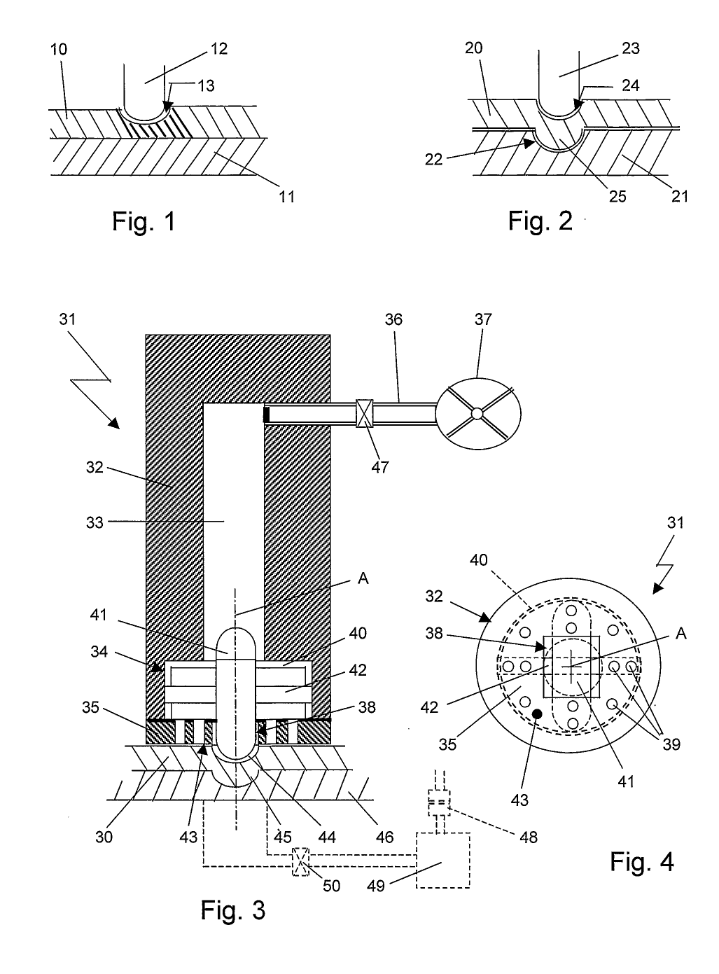

FIG. 1 illustrates a known arrangement of a fully supported carton board in contact with a creasing wheel,

FIG. 2 illustrates a known arrangement of a carton board supported by a channelled counter and in contact with a creasing wheel,

FIG. 3 is a sectional elevation of the apparatus of the invention, and

FIG. 4 is an end view of the apparatus of FIG. 3.

Referring now to FIG. 1, there is illustrated the creasing of a carton board 10 fully supported by a backing plate 11. A creasing wheel 12 and the carton board 10 move relative to each other to create a groove 13. The material of the carton board 10 displaced from the groove 13 can only transport into a compressed area of the carton board 10 beneath the groove 13, as depicted by closer section lines in that area in the Figure. This known method does not produce a commercially acceptable crease.

To overcome this problem the known method illustrated in FIG. 2 is performed. In this case, a carton board 20 is supported by a backing plate or counter 21. The counter 21 has a channel 22 formed therein, the channel 22 being positioned directly beneath a creasing wheel 23. The creasing wheel 23 and the carton board 20 move relative to each other to create a groove 24. The material of the carton board 20 displaced from the groove 24 can transport into the channel 22, and form a bead 25 on the underside of the board 20. By this means, the compression of the board 21 is avoided and the method enables the production of a commercially acceptable crease. The making of the counter 21 for a sample or short production run is time consuming and inconvenient, and a counter 21 must be cut for each different job to be done. In addition, the counter 21 must be positioned so that the transported carton board 20 is located exactly over the channels every time. Alternatively, the counter 21 may be made of a resilient silicon material to deform under the pressure of the creasing wheel, and the material of the carton board 20 displaced from the groove 24 depresses the resilient counter 21. However, this still causes undesirable compression of the carton board 21.

Referring now to FIGS. 3 and 4, there is shown a carton board 30 being operated on by apparatus 31 in accordance with the present invention. The apparatus 31 comprises an elongate body 32 having a central bore 33 therein. One end of the bore 33 has an enlarged part 34, and that end of the body 31 has a shoe 35 extending across the enlarged bore 34. The other end of the bore 33 communicates through a connecting tube 36 with a fan 37 or other suction device. The fan 37 creates a sub-ambient air pressure in the bores 33, 34 and at the one end of the body 32. A valve 47 controls the sub-ambient air pressure as required.

The shoe 35 has a slot 38 extending therethrough, and additionally perforations 39 so that the sub-ambient air pressure is transmitted to the outside of the body 32 over a substantial area of the shoe 35. Preferably, the shoe 35 is removable whereby shoes of differing dimensions may be mounted on the body. Connected to the shoe 35 is a wheel housing 40 in which a creasing wheel 41 is rotatably mounted on a spindle 42 to extend through the slot 38. The spindle 42 extends substantially parallel with the front surface 43 of the shoe 35. In addition, the position of the spindle 42 is adjustable within the housing 40 whereby the extent by which the creasing wheel 41 protrudes from the slot 38 may be varied to suit the carton board 30 being processed. The creasing wheel 41 may be removed from the wheel housing 40 and replaced by one of different dimensions, in particular thickness, if required for creasing a different carton board 30. The shoe 35 and wheel housing 40 are rotatable about axis A for tangential control of the creasing wheel 41 for the purpose described below. Axis A is substantially perpendicular to the front surface 43. Preferably, the front surface 43 has a low friction coating thereon, e.g. PTFE. The coating may be of Teflon (Registered Trade Mark).

Under the effect of the sub-ambient air pressure created at the outlet of the shoe 35, the carton board 30 is held in contact with the front surface 43 and hence in deformable contact with the creasing wheel 41. This creates a groove 44 in the carton board 30. The carton board 30 is supported in the apparatus 31 by a mat 46 that is porous to allow the sub-ambient air pressure to grip the carton board 30 locally to the shoe 35 in the area immediately adjacent the creasing wheel 41. In addition, the mat 46 is sufficiently soft to deform as the groove 44 is formed in the carton board 30. This provides a measure of “give” under the pressure of the creasing wheel 41, and the material displaced from the groove 44 can form a bead 45 on the carton board 30. Hence, a commercially acceptable crease can be produced by this method. The depth of the groove 44 may be varied as desired by adjustment of the amount of protrusion of the creasing wheel 41 beyond the front surface 43. The low friction front surface 43 facilitates the positioning of the carton board 30 when performing a short production run using a sheet feeder, conveyor or other transport mechanism to position the carton board 30 prior to creasing/cutting, and a take-off mechanism to remove the carton board 30 after that operation. However, the accurate positioning of the carton board 30 in relation to the channels of a counter in the known method is avoided. Rotation of the shoe 35 and wheel housing 40 about axis A enables curved grooves 44, or corners in the groove 44, to be created.

Alternative embodiments of apparatus in accordance with the invention will be apparent to persons skilled in the art. For example, instead of a sub-ambient air pressure within the body 32, pressure air directed at the front face 43 may be provided to force the carton board 30 into deforming contact with the creasing wheel 41 for example by means such as a pump 48 air reservoir 49 and valve 50 as shown in dashed lines in FIG. 3.

1. Apparatus for the creasing of a carton board (30) comprising a body (32) having a front surface (43), a creasing tool (41) mounted in the body (32), the creasing tool (41) protruding from the front surface (43), characterised by means (37, 48, 49) providing an air pressure differential at the front surface (43) whereby the pressure differential acts across a carton board (30) when disposed across the front surface (43) to force the carton board (30) into deforming contact with the creasing tool (41).

2. Apparatus as claimed in claim 1, characterised in that the front surface (43) has an opening (38) therein, the creasing tool (41) protruding from the opening (38).

3. Apparatus as claimed in claim 2, characterised in that the creasing tool (41) is a wheel.

4. Apparatus as claimed in claim 3, characterised in that the creasing wheel (41) is mounted in the body (32) for rotation about an axis (42) substantially parallel with the front surface (43),

5. Apparatus as claimed in claim 2, characterised in that the body (32) is an elongate hollow body having the front surface (43) at, and the opening (38) in, one end thereof.

6. Apparatus as claimed in claim 2, characterised in that the opening (38) comprises a slot communicating with the hollow interior (34) of the body (32).

7. Apparatus as claimed in claim 2, characterised in that the pressure differential providing means (37, 48, 49) comprises valve means (47, 50) operable to adjust the pressure differential.

8. Apparatus as claimed in claim 6, characterised in that the hollow interior (34) is connected to the pressure differential providing means (37).

9. Apparatus as claimed in claim 8, characterised in that the pressure differential providing means (37) is a fan.

10. Apparatus as claimed in claim 9, characterised in that the pressure differential providing means (37) provides a sub-ambient air pressure in the hollow interior (34) of the body (32).

11. Apparatus as claimed in claim 2, characterised in that the pressure differential providing means is a pump (48) and air reservoir (49).

12. Apparatus as claimed in claim 2, characterised in that the front surface (43) has a low friction coating thereon.

13. Apparatus as claimed in claim 12, characterised in that the coating is of PTFE.

14. Apparatus as claimed in claim 2, characterised in that the body (32) comprises a shoe (35) on the one end thereof, the front surface (43) being a surface of the shoe (35) and the shoe (35) having the opening (38) extending therethrough.

15. Apparatus as claimed in claim 14, characterised in that the shoe (35) is removable whereby shoes (35) of differing dimensions may be mounted on the body (32).

16. Apparatus as claimed in claim 14, characterised in that there is a sub-ambient air pressure in the hollow interior (34) of the body (32) and the shoe (35) has perforations (39) therethrough whereby the sub-ambient pressure within the body (32) causes a pressure differential across the shoe (35) over a substantial area of the shoe (35).

17. Apparatus as claimed in claim 2, characterised in that the position of the creasing tool (41) may be adjustable relative to the body (32), whereby the extent of protrusion of the tool (41) from body (32) may be adjusted.

18. Apparatus as claimed in claim 2, characterised in that the creasing tool (41) is removable from the body (32) whereby wheels (41) of differing dimensions may be mounted in the body (32).

19. Apparatus as claimed in claim 2, characterised in that the creasing tool (41) is mounted in the body (32) to be rotatable about an axis substantially perpendicular to the front surface (43).

20. Apparatus as claimed in claim 1, characterised by a supporting mat (46) on which a carton board (30) is supported when in the apparatus (31).

21. Apparatus as claimed in claim 20, characterised in that the mat (46) is porous to air.

22. Apparatus as claimed in claim 20, characterised in that the mat (46) is of a material that is deformable under the load applied by the creasing wheel (41) to a carton board (30).

23. A method of creasing a carton board (30) comprising bringing the carton board (30) into contact with a front surface (43) of a body (32), which has a creasing tool (41) mounted in the body (32), the creasing tool (41) protruding from the front surface (43), characterised by providing an air pressure differential at the front surface (43) whereby the pressure differential acts across a carton board (30) when disposed across the front surface (43) to force the carton board (30) into deforming contact with the creasing tool (41).

24. A method as claimed in claim 23, characterised by creating a sub-ambient pressure within the body (32).

25. A method as claimed in claim 23, characterised by directing pressure air at the front surface (43) to force the carton board (30) into deforming contact with the creasing tool (41).

26. A method as claimed in claim 23, characterised by adjusting the position of the creasing tool (41) relative to the body (32) whereby the extent of protrusion of the tool (41) from body (32) maybe adjusted.

27. A method as claimed in claim 23, characterised by supporting a carton board (30) on a supporting mat (46).

28. A method as claimed in claim 27, characterised by supporting a carton board (30) on a supporting mat (46) that is porous to air and is of a material that is deformable under the load applied by the creasing wheel (41) to a carton board (30).

29. Apparatus for the creasing of a carton board (30) substantially as hereinbefore described with reference to and as illustrated in FIGS. 3 and 4 of the accompanying drawing.

30. A method creasing a carton board (30) substantially as hereinbefore described with reference to FIGS. 3 and 4 of the accompanying drawing.
